(19) United States
(12) Patent Application Publication
(10) Pub. No.: US 2026/0121456 A1
(43) Pub. Date: Apr. 30, 2026

(54) WIRELESS CHARGING CONCENTRATE COIL

(71) Applicant: Google LLC, Mountain View, CA (US)

(72) Inventors: Qi Tian, San Jose, CA (US); Liang Jia, Palo Alto, CA (US); Srikanth Lakshmikanthan, Milpitas, CA (US)

(21) Appl. No.: 19/123,655

(22) PCT Filed: Dec. 14, 2022
(86) PCT No.: PCT/US2022/081599

§ 371 Date: Apr. 23, 2025

(51) Int. Cl. H02J 50/50; H02J 50/00; H02J 50/10; H02J 50/70

(52) U.S. Cl. CPC H02J 50/502; H02J 50/005; H02J 50/10; H02J 50/70

(57) ABSTRACT

An electronic device (100) includes a wireless charging coil (118, 122) positioned to wirelessly transmit or receive electrical energy; and a concentrate coil (126) positioned parallel to the wireless charging coil, the concentrate coil comprising a plurality of windings that includes at least an inner winding and an outer winding, wherein the inner winding and the outer winding of the concentrate coil are shorted together, and wherein the inner winding of the concentrate coil is axially aligned with the wireless charging coil.

### BACKGROUND

Computing devices, such as smartphones, laptops, wearable devices, and tablets, may include wireless charging capabilities. Computing devices may operate as wireless charging source devices that wirelessly provide power or wireless charging sink devices that wirelessly receive power. For instance, a wireless charging sink device may include a receiver coil and other components capable of transducing a magnetic field into an electrical power signal that may be used to charge a battery of the computing device or otherwise operate components of the computing device. Similarly, a wireless charging source device may include a power supply that output a signal to a transmitter coil that causes the transmitter coil to generate a magnetic field.

### SUMMARY

In general, aspects of this disclosure are directed to electronic devices that perform wireless charging with the assistance of concentrate coils. An efficiency of a wireless charging link between a wireless charging source device and a wireless charging sink device may be a function of a displacement between a transmitter coil of a wireless charging source device and a receiver coil of a wireless charging sink device. For instance, as the displacement increases, the efficiency of the wireless charging link may decrease. Once the displacement becomes too great, the wireless charging link may cease to function (i.e., such that no or minimal power can be transferred). This function may undesirably reduce placement freedom between transmitter and receiver coils.

In accordance with one or more aspects of this disclosure, an electronic device may include a wireless charging concentrate coil. The concentrate coil may be placed over a transmitter or receiver coil and may include several windings. The windings of the concentrate coil may increase an efficiency of a wireless charging link between displaced transmitter and receiver coils. In this way, the concentrate coil may provide for greater placement freedom between transmitter and receiver coils.

In one example, an electronic device includes a wireless charging coil positioned to wirelessly transmit or receive electrical energy; and a concentrate coil positioned parallel to the wireless charging coil, the concentrate coil comprising a plurality of windings that includes at least an inner winding and an outer winding, wherein the inner winding and the outer winding of the concentrate coil are shorted together, and wherein the inner winding of the concentrate coil is axially aligned with the wireless charging coil.

The details of one or more examples are set forth in the accompanying drawings and the description below. Other features, objects, and advantages of the disclosure will be apparent from the description and drawings, and from the claims.

### BRIEF DESCRIPTION OF DRAWINGS

FIG. 1A is a block diagram illustrating a system that includes a wireless charging source device and a wireless charging sink device, at least one of which includes a concentrate coil, in accordance with one or more aspects of this disclosure.

FIGS. 1B and 1C are conceptual diagrams illustrating cross-sections of a transmitter coil and a receiver coil.

FIG. 2A is a schematic diagram illustrating an example electronic device with a concentrate coil and a wireless charging coil, in accordance with one or more aspects of this disclosure.

FIGS. 2B-2D are schematic diagrams of wireless charging coils having various misalignments, in accordance with one or more aspects of the disclosure.

FIGS. 3A-3H are schematic diagrams of example concentrate coils, in accordance with one or more aspects of the disclosure.

### DETAILED DESCRIPTION

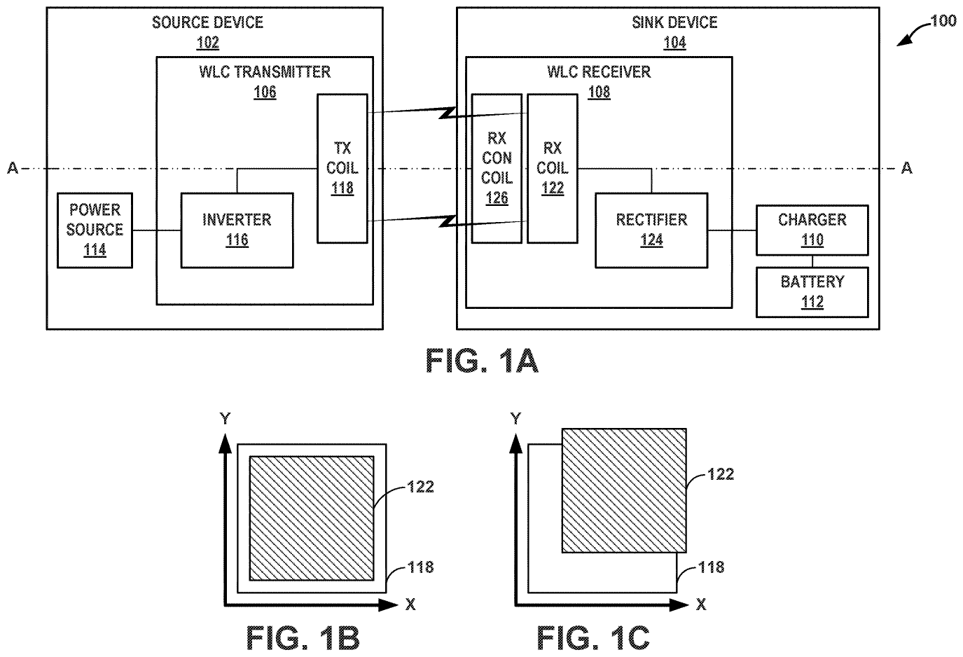

FIG. 1A is a block diagram illustrating a system that includes a wireless charging source device and a wireless charging sink device, at least one of which includes a concentrate coil, in accordance with one or more aspects of this disclosure. As shown in FIG. 1A, system 100 may include wireless charging source device 102 (“source device 102”) and wireless charging sink device 104 (“sink device 104”).

Source device 102 may be any type of device that wirelessly provides power to another device. Examples of source device 102 include, but are not limited to, a charging pad, a charging stand, an alarm clock, a power bank, a mobile phone, a camera device, a tablet computer, a smart display, a laptop computer, a desktop computer, a gaming system, a media player, an e-book reader, a television platform, a vehicle infotainment system or head unit, a vehicle surface with integrated charging, or a wearable computing device. As shown in FIG. 1A, source device 102 may include wireless charging (WLC) transmitter 106 and power source 114.

Power source 114 may be any component capable of providing electrical power to other components of source device 102. Examples of power source 114 include, but are not limited to, batteries, solar panels, wall adapters, wireless charging receive coils, etc. As shown in FIG. 1A, power source 114 may provide electrical power (e.g., direct current (DC) electrical power) to WLC transmitter 106.

WLC transmitter 106 may be configured to wirelessly provide power to another device. In some examples, WLC transmitter 106 may be compliant with (e.g., operate in accordance with) a wireless charging standard such as the Qi specification published by the Wireless Power Consortium (e.g., available at wirelesspowerconsortium.com/knowledge-base/specifications/download-the-qi-specifications.html). As shown in FIG. 1A, WLC transmitter 106 may include inverter 116, transmitter (Tx) coil 118, and controller 120.

Inverter 116 may be configured to convert a direct current (DC) signal into an alternating current (AC) signal (e.g., to energize Tx coil 118). For instance, inverter 116 may convert a DC power signal received from power source 114 into an AC power signal, and provide the AC power signal to Tx coil 118. In some examples, inverter 116 may be an active full bridge inverter that includes a plurality of switches. Operation of the plurality of switches may be controlled by a controller.

Tx coil 118 may be configured to generate a magnetic field proportional to a power signal flowing through Tx coil 118. For instance, Tx coil 118 may generate a magnetic field having properties proportional to the AC power signal output to Tx coil 118 from inverter 116.

Sink device 104 may be any type of device that operates at least in part using power wirelessly received from another device. Examples of sink device 104 include, but are not limited to, a power bank, a mobile phone, a camera device, a stylus, a tablet computer, a smart display, a laptop computer, a desktop computer, a gaming system, a media player, an e-book reader, a television platform, or a wearable computing device. As shown in FIG. 1A, sink device 104 may include wireless charging (WLC) receiver 108, charger 110, and battery 112.

WLC receiver 108 may be configured to wirelessly receive power from another device. In some examples, WLC receiver 108 may be compliant with (e.g., operate in accordance with) a wireless charging standard such as the Qi specification published by the Wireless Power Consortium (e.g., available at wirelesspowerconsortium.com/knowledge-base/specifications/download-the-qi-specifications.html). As shown in FIG. 1A, WLC receiver 108 may include receiver (Rx) coil 122, and rectifier 124.

Rx coil 122 may be configured to transduce a magnetic field into a power signal. For instance, Rx coil 122 may transduce the magnetic field generated by Tx coil 118 into an AC power signal having properties proportional to the magnetic field (e.g., and thus proportional to AC power signal output to Tx coil 118 from inverter 116). Rx coil 122 may output the transduced AC power signal to one or more components of WLC receiver 108, such as rectifier 124.

Rectifier 124 may be configured to convert an AC signal into a DC signal. For instance, rectifier 124 may convert an AC power signal received from Rx coil 122 into a DC power signal, and provide the DC power signal to another component of sink device 104, such as charger 110. In some examples, rectifier 124 may be an active full bridge rectifier that includes a plurality of switches. In this sense, rectifier 124 may be considered to be an active rectifier (e.g., as opposed to a bridge formed entirely of passive diodes). Operation of the plurality of switches may be controlled by a controller. In other examples, rectifier 124 may be a passive rectifier.

Components of sink device 104 may utilize the DC power signal output by WLC receiver 108 to perform various operations. For instance, charger 110 may utilize the DC power signal output by WLC receiver 108 to charge battery 112.

In operation, Tx coil 118 and Rx coil 122 may be moved into proximity of each other. Depending on the distance between Tx coil 118 and Rx coil 122, only a fraction of the magnetic flux generated by Tx coil 118 penetrates Rx coil 122 and contributes to the power transmission. The more flux reaches Rx coil 122, the better the coils are coupled. The grade of coupling may be expressed by the coupling factor k. The coupling factor may be impacted by a distance between Tx coil 118 and Rx coil 122 and a relative size of Tx coil 118 and Rx coil 122. Starting from perfect axial alignment, a displacement of Tx coil 118 relative to Rx coil 122 causes a decrease of the coupling factor k. Once the displacement of Tx coil 118 relative to Rx coil 122 becomes great enough, the coupling factor k may drop to zero and no wireless power transfer may occur.

FIGS. 1B and 1C are conceptual diagrams illustrating cross-sections of Tx coil 118 and Rx coil 122 along line A-A of FIG. 1A. FIG. 1B shows Tx coil 118 and Rx coil 122 in perfect axial alignment whereas FIG. 1C shows an axial displacement between Tx coil 118 and Rx coil 122. As such, the coupling factor k will be lower in the scenario of FIG. 1C than in the scenario of FIG. 1B. The impact of increasing displacement reducing coupling factor may undesirably reduce placement freedom between Tx coil 118 and Rx coil 122.

In accordance with one or more aspects of this disclosure, an electronic device (e.g., source device 102 and/or sink device 104) may include wireless charging concentrate coil 126 (concentrate coil 126 or Rx con coil 126). As shown in FIG. 1A, concentrate coil 126 may be placed over Rx coil 122. Similarly, concentrate coil 126 may be placed over Tx coil 118. Concentrate coil 126 may include several windings. The magnetic flux generated by Tx coil 118 may be better coupled into Rx coil 122 (i.e., Tx coil 118 may be electromagnetically coupled with Rx coil 122 through concentrate coil 126). As such, the windings of concentrate coil 126 may increase an efficiency of a wireless charging link between Tx coil 118 and Rx coil 122.

In some examples, the presence of concentrate coil 126 may enable a wireless charging link to form between Tx coil 118 and Rx coil 122 where a displacement between Tx coil 118 and Rx coil 122 would otherwise inhibit such a link. For instance, in the example of FIG. 1C, where the displacement between Tx coil 118 and Rx coil 122 would inhibit a link, the presence of concentrate coil 126 may still enable power to be wirelessly transferred between source device 102 and sink device 104. In this way, concentrate coil 126 may provide for greater placement freedom between Tx coil 118 and Rx coil 122, and thereby provide for greater placement freedom between source device 102 and sink device 104.

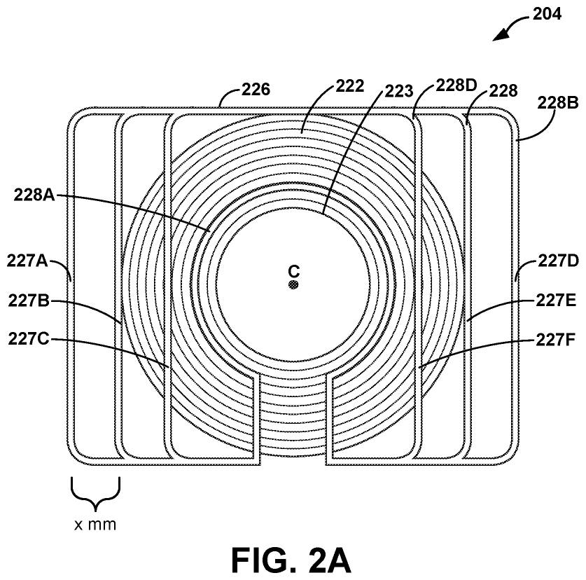

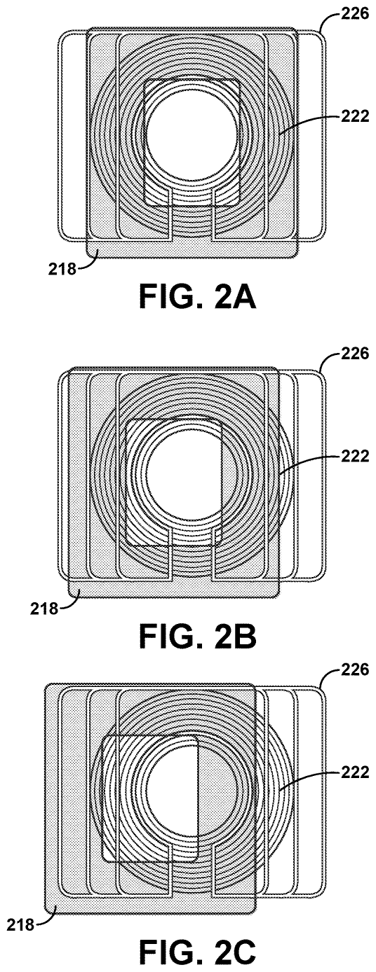

FIG. 2A is a schematic diagram illustrating an example electronic device with a concentrate coil and a wireless charging coil, in accordance with one or more aspects of this disclosure. Electronic device 204 of FIG. 2A may be an example of sink device 104 of FIG. 1A. Similarly, concentrate coil 226 and wireless charging coil 222 may respectively be examples of concentrate coil 126 and Rx coil 122 of FIG. 1A. As such, in some examples, wireless charging coil 222 may be referred to as Rx coil 222.

Wireless charging coil 222 may include a plurality of turns about center point C. The turns of wireless charging coil 222 may transduce a magnetic field into an alternating current electrical signal.

Concentrate coil 226 may be placed on top of wireless charging coil 222 (i.e., between wireless charging coil 222 and a wireless charging coil of another device). In some examples, one or more additional components may be included. For instance, a nano-crystalline layer may be included under wireless charging coil 222.

As shown in FIG. 2A, concentrate coil 226 may include a plurality of windings 228A-228D (collectively “windings 228”). Windings 228 may include an inner winding (e.g., winding 228A) and an outer winding (e.g., winding 228B). In some examples, windings 228 may include one or more intermediate windings (e.g., windings between the inner winding and the outer winding, such as windings 228C and 228D). While illustrated in FIG. 2 as including four windings, windings 228 may include two or more windings (e.g., 2, 3, 4, 5, 6, 7, 8, etc.). Windings 228 may be formed of legs. For instance, winding 228B may be formed of legs 227A and 227D. Similarly, winding 228C may be formed of legs 227B and 227E, and winding 228D may be formed of legs 227C and 227F. As shown in FIG. 2A, legs of legs 227 may be spaced apart from each other (e.g., by x millimeters (mm)).

Windings 228 of concentrate coil 226 may overlap each other. For instance, as shown in FIG. 2A, windings 228 may all overlap each other. In some examples, windings 228 may be variably sized and/or positioned (e.g., windings 228 may be different sizes). For instance, outer winding 228B may be larger than inner winding 228A. In some examples, windings 228 may be misaligned. For instance, windings 228 may be shifted relatively from each other in a single axis (e.g., misaligned in a single axis, such as x or y), or in two axes (e.g., misaligned in a two axes, such as x and y). As shown in FIG. 2, windings 228 may be misaligned in a single axis (e.g., legs of windings 228 may be shifted horizontally relative to the page).

Windings 228, or at least legs 227, may all be on a single layer (e.g., concentrate coil 226 may not be a multilayer coil). For instance, legs 227 may all be co-planar with each other. Similarly, in some examples, windings 227 may all be co-planar.

Windings 228 may each be formed of any suitable conductor (e.g., copper, gold, etc.). In some examples, windings 228 may be formed as a single piece of material (e.g., via deposition, stamping, etching, etc.). As shown in FIG. 2A, one or more of windings 228 may be shorted together (e.g., directly electrically coupled). For instance, outer winding 228B and inner winding 228A may be shorted together. In some examples, all of windings 228 may be shorted together.

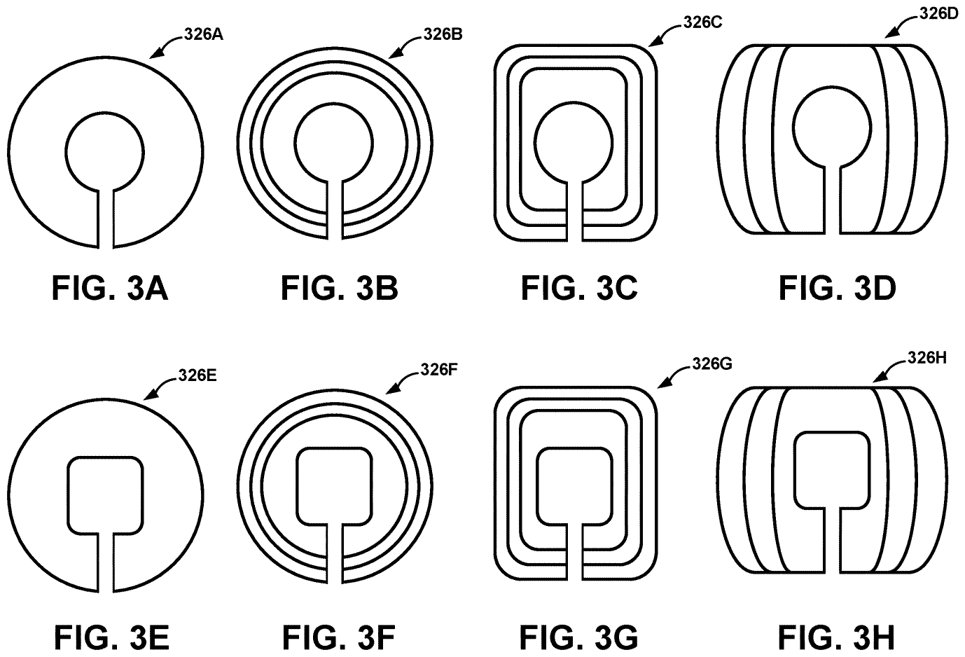

While illustrated respectively as rectangular and circular, concentrate coil 226 and wireless charging coil 222 may be a variety of shapes. For instance, wireless charging coil 222 may be rectangular and/or one or more windings of concentrate coil 226 may be circular (other than inner winding 228A, which is illustrated as circular). Several examples of shapes of concentrate coil 226 are provided in FIGS. 3A-3H. As can be seen from FIGS. 3A-3H, in some examples, the windings (e.g., windings 228) may all be concentric with one another. In other examples, the windings (e.g., windings 228) may not all be concentric with one another (i.e., may be non-concentric with one another).

In some examples, a shape of inner winding 228A may match a shape of inner turn 223 of wireless charging coil 222. In some examples, a size of inner winding 228A may match a size of inner turn 223 of wireless charging coil 222.

Concentrate coil 226 may be aligned with wireless charging coil 222. For instance, at least inner winding 228A may be axially aligned with inner turn 223 of wireless charging coil 222 (e.g., as shown in FIG. 2A, inner winding 228A may be axially aligned with inner turn 223 of wireless charging coil about point C).

Concentrate coil 226 may not be electrically connected to wireless charging coil 222 (e.g., have no electrical connection to wireless charging coil 222). In some examples, concentrate coil 226 may operate passively. For instance, concentrate coil 226 may not be driven by any signal generator of device 204. As such, no switches may be needed to control operation of concentrate coil 226.

In operation, an electromagnetic field may induce a current in one or more of legs 227. This current may flow through at least inner winding 228A of concentrate coil 226. The flow of current through inner winding 228A may generate an electromagnetic field that, when inner winding 228A is aligned with wireless charging coil 222, couples well into wireless charging coil 222. While recited as inducing a flow of current through inner winding 228A, induced current may flow through additional, if not all, windings of windings 228.

FIGS. 2B-2D are schematic diagrams of wireless charging coils having various misalignments, in accordance with one or more aspects of the disclosure. Each of the scenarios depicted in FIGS. 2B-2D includes a Tx coil 218, a Rx coil 222, and a concentrate coil 222. Tx coil 218 may be an example of Tx coil 118 of FIG. 1A and included in a source device. Rx coil 222 and concentrate coil 226 may respectively be examples of concentrate coil 126 and Rx coil 122 of FIG. 1A, and may be included in a sink device. For simplicity of illustration, legs 227 and windings 228 are not labeled on FIGS. 2B-2D, however the reference numbers from FIG. 2A apply.

FIG. 2B illustrates a scenario with zero misalignment between Tx coil 218 and Rx coil 222, FIG. 2C illustrates a scenario with x mm misalignment between Tx coil 218 and Rx coil 222, and FIG. 2D illustrates a scenario with 2x mm misalignment between Tx coil 218 and Rx coil 222 (i.e., twice the misalignment of FIG. 2C).

In the scenario of FIG. 2B, legs 227B, 227C, 227E, and 227F may obtain a good electromagnetic coupling with Tx coil 218. As such, in this scenario, an electromagnetic field generated by Tx coil 218 may induce current in legs 227B, 227C, 227E, and 227F, which may in turn cause a current to flow through inner winding 228A. This current flowing through inner winding 228A may electromagnetically couple into Rx coil 222, and induce a current to flow in Rx coil 222 (e.g., thereby concentrating the electromagnetic field generated by Tx coil 218 into Rx coil 222).

In the scenario of FIG. 2C, legs 227B, 227C, and 227F may obtain a good electromagnetic coupling with Tx coil 218. As such, in this scenario, an electromagnetic field generated by Tx coil 218 may induce current in legs 227B, 227C, and 227F, which may in turn cause a current to flow through inner winding 228A. This current flowing through inner winding 228A may electromagnetically couple into Rx coil 222, and induce a current to flow in Rx coil 222 (e.g., thereby concentrating the electromagnetic field generated by Tx coil 218 into Rx coil 222).

In the scenario of FIG. 2D, legs 227A, 227B, and 227F may obtain a good electromagnetic coupling with Tx coil 218. As such, in this scenario, an electromagnetic field generated by Tx coil 218 may induce current in legs 227A, 227B, and 227F, which may in turn cause a current to flow through inner winding 228A. This current flowing through inner winding 228A may electromagnetically couple into Rx coil 222, and induce a current to flow in Rx coil 222 (e.g., thereby concentrating the electromagnetic field generated by Tx coil 218 into Rx coil 222). In at least the example of FIG. 2D, the presence of concentrate coil 226 may enable transfer of energy between Tx coil 218 and Rx coil 222 where absence of concentrate coil 226 with such misalignment may prevent said energy transfer (at least with useful coupling factors).

Table 1 below provides example coupling factors for the scenarios of FIGS. 2B-2D. In general, every 0.01 increasement of coupling factor k may result in a ˜1% efficiency improvement. As can be seen from Table 1, the presence of a concentrate coil, such as concentrate coil 226, may significantly improve the coupling factor (e.g., particularly under high misalignment conditions).

TABLE 1

| | Without | With |
|---|---|---|
| | Concentrate | Concentrate |
| Misalignment | Coil | Coil |

| | | | |
|---|---|---|---|
| 0 | mm | 0.81 | 0.81 |
| 5 | mm | 0.75 | 0.76 |
| 10 | mm | 0.56 | 0.58 |

FIGS. 3A-3H are schematic diagrams of example concentrate coils, in accordance with one or more aspects of the disclosure. Each of concentrate coils 326A-326H is a different design of a concentrate coil, each of which may be an example of concentrate coil 126 of FIG. 1A or concentrate coil 226 of FIGS. 2A-2D.

The following numbered examples may illustrate one or more aspects of this disclosure:

Example 1. An electronic device comprising: a wireless charging coil positioned to wirelessly transmit or receive electrical energy; and a concentrate coil positioned parallel to the wireless charging coil, the concentrate coil comprising a plurality of windings that includes at least an inner winding and an outer winding, wherein the inner winding and the outer winding of the concentrate coil are shorted together, and wherein the inner winding of the concentrate coil is axially aligned with the wireless charging coil.

Example 2. The electronic device of example 1, wherein wireless charging coil of the electronic device electromagnetically couples a wireless charging coil of another device through the concentrate coil.

Example 3. The electronic device of example 1 or example 2, wherein the plurality of windings comprises at least three windings.

Example 4. The electronic device of any of examples 1-3, wherein the plurality of windings are different sizes.

Example 5. The electronic device of any of examples 1-4, wherein the plurality of windings overlap.

Example 6. The electronic device of any of examples 1-4, wherein the plurality of windings are misaligned.

Example 7. The electronic device of example 6, wherein the plurality of windings are misaligned in a single axis.

Example 8. The electronic device of example 6, wherein the plurality of windings are misaligned in two axes.

Example 9. The electronic device of any of examples 1-8, wherein the concentrate coil is a single layer.

Example 10. The electronic device of any of examples 1-9, wherein the concentrate coil is not electrically connected to the wireless charging coil.

Example 11. The electronic device of any of examples 1-10, wherein the concentrate coil operates passively.

Example 12. The electronic device of any of examples 1-11, wherein the electronic device comprises a wireless charging sink device, the wireless charging sink device further comprising: a rectifier configured to convert an alternating current generated by the wireless charging coil into a direct current signal; a battery; and a charger configured to charge the battery using energy of the direct current signal.

Example 13. The electronic device of any of examples 1-11, wherein the electronic device comprises a wireless charging source device, the wireless charging source device further comprising: an inverter configured to energize the wireless charging coil with an alternating current signal.

Example 14. The electronic device of any of examples 1-13, wherein the windings of the concentrate coil are co-planar.

Example 15. The electronic device of any of examples 1-14, wherein the windings of the concentrate coil are non-concentric with one another.

Various aspects have been described in this disclosure. These and other aspects are within the scope of the following claims.

1. An electronic device comprising:
a wireless charging coil positioned to wirelessly transmit or receive electrical energy; and
a concentrate coil positioned parallel to the wireless charging coil, the concentrate coil comprising a plurality of windings that includes at least an inner winding and an outer winding, wherein the inner winding and the outer winding of the concentrate coil are shorted together, and wherein the inner winding of the concentrate coil is axially aligned with the wireless charging coil.

2. The electronic device of claim 1, wherein wireless charging coil of the electronic device electromagnetically couples a wireless charging coil of another device through the concentrate coil.

3. The electronic device of claim 1, wherein the plurality of windings comprises at least three windings.

4. The electronic device of claim 1, wherein the plurality of windings are different sizes.

5. The electronic device of claim 1, wherein the plurality of windings overlap.

6. The electronic device of claim 1, wherein the plurality of windings are misaligned.

7. The electronic device of claim 6, wherein the plurality of windings are misaligned in a single axis.

8. The electronic device of claim 6, wherein the plurality of windings are misaligned in two axes.

9. The electronic device of claim 1, wherein the concentrate coil is a single layer.

10. The electronic device of claim 1, wherein the concentrate coil is not electrically connected to the wireless charging coil.

11. The electronic device of claim 1, wherein the concentrate coil operates passively.

12. The electronic device of claim 1, wherein the electronic device comprises a wireless charging sink device, the wireless charging sink device further comprising:
a rectifier configured to convert an alternating current generated by the wireless charging coil into a direct current signal;
a battery; and
a charger configured to charge the battery using energy of the direct current signal.

13. The electronic device of claim 1, wherein the electronic device comprises a wireless charging source device, the wireless charging source device further comprising:
an inverter configured to energize the wireless charging coil with an alternating current signal.

14. The electronic device of claim 1, wherein the windings of the concentrate coil are co-planar.

15. The electronic device of claim 1, wherein the windings of the concentrate coil are non-concentric with one another.

16. The electronic device of claim 1, wherein the inner winding is circular, and wherein the outer winding and at least one other winding of the plurality of windings are rectangular.
